(19) United States
(12) Patent Application Publication
(10) Pub. No.: US 2021/0097513 A1
(43) Pub. Date: Apr. 1, 2021

(54) MULTI-FUNCTIONAL AUTOMATED TELLER MACHINES

(71) Applicant: Wells Fargo Bank, N.A., San Francisco, CA (US)

(72) Inventors: Steve Nicholson, Pleasant Hill, CA (US); Alma Jensen, Castro Valley, CA (US); Linda Huang, San Francisco, CA (US); Peter S. Kim, Belmont, CA (US)

(21) Appl. No.: 14/987,390

(22) Filed: Jan. 4, 2016

Related U.S. Application Data
(60) Provisional application No. 62/248,192, filed on Oct. 29, 2015.

(51) Int. Cl. G06Q 20/10; G06Q 30/06

(52) U.S. Cl. CPC G06Q 20/1085; G06Q 30/0631

(57) ABSTRACT

The disclosure describes a method for managing user accounts. The method may include receiving, by a computing device, a user identifier associated with a user of an automated teller machine and a location identifier associated with the automated teller-machine. The method may further include determining, by the computing device and based on the user identifier, user data that includes at least one of user financial data, user preferences data, or user personal data. The method may further include determining, by the computing device and based on the location identifier and the user data, a recommended action for the user of the automated teller machine. The method may further include sending, by the computing device and to the automated teller machine, information associated with the recommended action to be displayed to the user on a display of the automated teller machine.

This application claims the benefit of U.S. Provisional Application No. 62/248,192, filed Oct. 29, 2015, the entire content of each of which is incorporated by reference herein in its entirety.

### TECHNICAL FIELD

The invention relates to automated teller machines.

### BACKGROUND

Automated teller machines (ATMs) have long provided account holders with a convenient option for making deposits to and withdrawals from their accounts at financial institutions from remote locations. For example, financial institutions may provide a number of ATMs at both its retail banking locations and at other remote locations that may be more convenient for account holders such as, for example, office buildings, grocery stores, college campuses, and malls. Additionally, certain financial institutions may allow its account holders to perform transactions using ATMs serviced by other financial institutions, providing an even wider range of locations for the account holder to perform transactions. In addition to providing more convenient locations, ATMs may also provide account holders with more convenient hours of operation by being available for use during times when a financial institution's retail banking locations are closed, otherwise unavailable, or busy. Thus, ATMs provide a wide range of locations and times at which account holders may perform deposits and withdrawals, making these transactions more convenient than if the account holder were limited to performing them only at a retail banking location during its operating hours.

### SUMMARY

In general, this disclosure describes techniques for providing a multifunctional automated teller machine (ATM) system. Conventionally, ATM systems primarily allow account holders to interact with their accounts at financial institutions (e.g., withdraw and deposit funds) solely based on input from the account holders. In order to present a more robust, convenient, and efficient system to account holders, the disclosed techniques enable an ATM system to perform actions in addition to merely withdrawals or deposits. According to the disclosed techniques, a multifunctional ATM unit may be configured to analyze information about the account holder and recommend actions to be taken by the account holder based on that information. For example, in addition to the information received from the account holder during a withdrawal or deposit transaction, the multifunctional ATM unit described in this disclosure may be configured to access the account holder's financial profile data from the financial institution, the account holder's personal and/or work calendar, the account holder's social media accounts, and the like. The multifunctional ATM unit may then determine recommend actions, products, and/or services that are customized based on the account holder's information.

In one example, this disclosure is directed to a method comprising receiving, by a computing device, a user identifier associated with a user of an automated teller machine and a location identifier associated with the automated teller-machine; determining, by the computing device and based on the user identifier, user data that includes at least one of user financial data, user preferences data, or user personal data; determining, by the computing device and based on the location identifier and the user data, a recommended action for the user of the automated teller machine; and sending, by the computing device and to the automated teller machine, information associated with the recommended action to be displayed to the user on a display of the automated teller machine.

In another example, this disclosure is directed to a computing device comprising an interface and one or more processors. The interface is configured to receive, from an automated teller machine, a user identifier associated with a user of the automated teller machine and a location identifier associated with the automated teller-machine. The one or more processors are configured to determine, based on the user identifier, user data that includes at least one of user financial data, user preferences data, or user personal data; and determine, based on the location identifier and the user data, a recommended action for the user of the automated teller machine. The interface is further configured to send, to the automated teller machine, information associated with the recommended action to be displayed on a display of the automated teller machine.

In a further example, this disclosure is directed to a non-transitory computer-readable storage medium having stored thereon instructions that, when executed, cause a processor to determine, based on a user identifier associated with a user of an automated teller machine, user data that includes at least one of user financial data, user preferences data, or user personal data; and determine, based on a location identifier associated with the automated teller machine and the user data, a recommended action for the user of the automated teller machine.

The details of one or more examples of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating an example multifunctional ATM system that includes a multifunctional ATM unit configured to provide recommended actions to a user of an ATM based on user input, information stored by a financial institution, and/or information retrieved from one or more other sources, in accordance with the techniques of this disclosure.

FIG. 2 is a block diagram illustrating a computing device for executing a multifunctional ATM, as well as a database and user personal data, which may be accessed by the computer device for determining recommended actions for a user of an ATM.

FIGS. 3A-3D illustrate example graphical user interfaces (“GUI”s) on the display of the ATM showing recommended actions that have been determined by the multifunctional ATM unit and allowing for user input to accept, reject, or otherwise respond to the recommended action, in accordance with the techniques of this disclosure.

FIG. 4 is a flowchart illustrating an example operation of a multifunctional ATM unit of the multifunctional ATM system, in accordance with the techniques of this disclosure.

### DETAILED DESCRIPTION

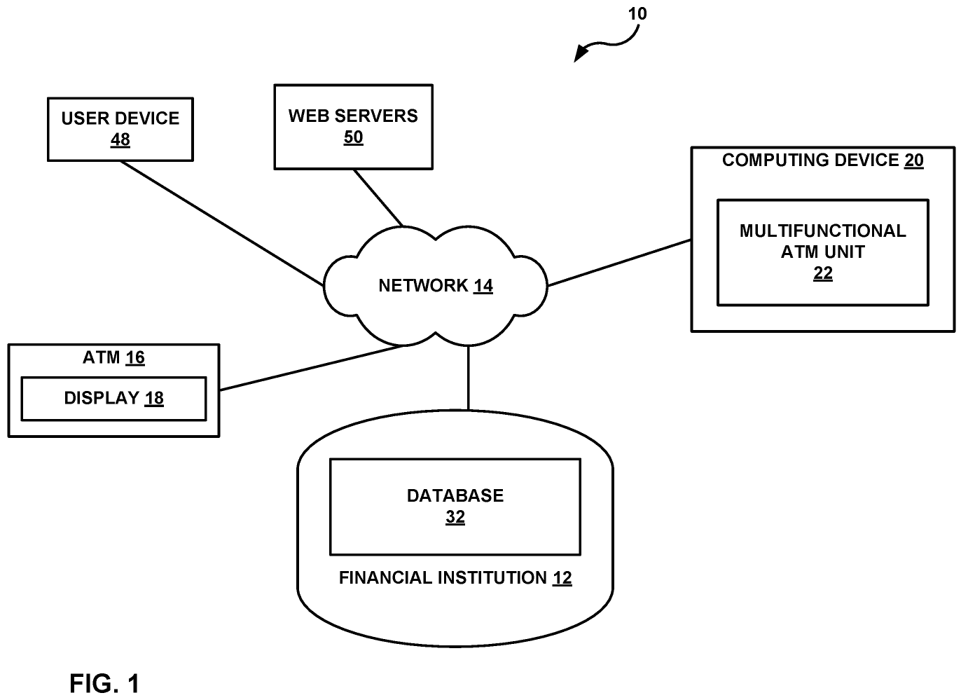

FIG. 1 is a block diagram illustrating an example multifunctional ATM system 10 that includes a multifunctional ATM unit 22 configured to provide recommended actions to a user of ATM 16 based on user input, information stored by financial institution 12, and/or information retrieved from one or more other sources, in accordance with the techniques of this disclosure.

In this example, multifunctional ATM system 10 includes an ATM 16, financial institution 12, a computing device 20 executing multifunctional ATM unit 22, at least one user device 48, and one or more web servers 50 in communication with each other via network 14. Network 14 may comprise a private network associated with financial institution 12 or may comprise a public network, such as the Internet. Although illustrated as a single entity, network 14 may comprise a combination of networks. ATM 16 may include a display 18 on which a graphical user interface (GUI) may be displayed or presented to a user of ATM 16. Financial institution 12 may include database 32 that stores user account information and other data associated with bank customers and bank-owned ATMs.

ATM 16 may be a device used to perform a variety of transactions. ATM 16 may be located at a retail banking location or other convenient location such as a grocery store, mall, college campus, or any other suitable location. ATM 16 may include display 18 for displaying information and/or receiving inputs. For example, display 18 may present a user with a GUI that displays options for completing one or more transactions. In some examples, display 18 may include a touchscreen for receiving information from the user indicating a selection via the displayed GUI. Alternatively or in addition, ATM 16 may include a keypad or other input device for receiving inputs.

ATM 16 may also include components for vending or accepting cash and/or checks for various transactions including, for example, conventional deposits or withdrawals, exchange of local currency for foreign currency or vice versa, and/or withdrawal of foreign currency. ATM 16 may also include a printer component for printing documents for various transactions including, for example, receipts for deposits, receipts for the purchase of goods for pickup from a merchant, and/or gift cards for redemption at a merchant. ATM 16 may also include a component to dispense envelopes. ATM 16 may also include a component to dispense cash. ATM 16 may also include a component to dispense cash within an envelope.

The components of ATM 16 described herein may be separate components, each dedicated to a separate function, or may be combined in any suitable number of components to perform the functions described herein. For example, ATM 16 may include one component for printing receipts and another for printing gift cards. Alternatively, ATM 16 may include a single component for printing both receipts and gift cards. The single component may include different subcomponents used for performing different tasks or may use the same subcomponents for each task according to particular needs.

A GUI presented on display 18 may allow a user to interact with ATM 16 by display of graphical icons and visual indicators. For example, display 18 may present a GUI that displays recommended actions and/or other options to a user. In certain examples, display 18 may be a touch sensitive screen and may present one or more touch sensitive GUI elements. For example, a user may be able to interact with ATM 16 to respond to options displayed on display 18 and initiate an action by touching one or more of the touch sensitive GUI elements displayed on display 18. For example, display 18 may be a presence-sensitive display that displays a GUI and receives input from a user using capacitive, inductive, and/or optical detection at or near the presence sensitive display. Alternatively or in addition, a user may be able to interact with ATM 16 to respond to options displayed on display 18 and initiate an action by using any suitable input device such as, for example, a keyboard, touchpad, and/or any other suitable input device. Display 18 may comprise a cathode ray tube (CRT) monitor, a liquid crystal display (LCD), organic light emitting diode (OLED), or any other type of display device that can generate intelligible output to a user.

Financial institution 12 may be a traditional bank or credit union with the capability to maintain user accounts. For example, financial institution 12 may maintain checking, savings, and/or investment accounts for account holders. Financial institution 12 may issue ATM access to accounts within financial institution 12 and/or accounts at other institutions. In other cases, financial institution 12 may be a third-party for storing information for one or more traditional banks or credit unions but may not necessarily maintain any user accounts within financial institution 12.

Database 32 may be a data structure for storing data related to financial institution 12. Although database 32 is illustrated as being stored within financial institution 12, database 32 may be stored by any suitable party and in any suitable location according to particular needs. For example, database 32 may be stored and maintained by a third-party vendor that stores and maintains data. Although illustrated as a single database 32, any suitable number of databases may be used for storing the data described according to particular needs.

Computing device 20 may be a centralized computing device configured to execute multifunctional ATM unit 22 for providing ATM transactions, including non-traditional ATM transactions, and/or for determining recommended actions to a user of ATM 16. For example, computing device 20 may comprise a cluster of one or more computers, workstations, servers, and the like. Although illustrated as being outside of financial institution 12, computing device 20 configured to execute multifunctional ATM unit 22 may be physically or virtually included within an internal network of financial institution 12. Alternatively, computing device 20 configured to execute multifunctional ATM unit 22 may be physically or virtually included in a network hosted by a third-party vendor. For example, a vendor of financial institution 12 may store and maintain multifunctional ATM unit 22 for financial institution 12 and/or may provide the functions of multifunctional ATM unit 22 as a service to financial institution 12. Although shown as being separate from ATM 16, in certain examples, multifunctional ATM unit 22 may be stored and executed within ATM 16.

User device 48 may be a device associated with a user of ATM 16. User device 48 may include one or more computing devices including, for example, one or more desktop computer, laptop, workstation, and/or wireless device such as a wireless phone or tablet. User device 48 may be configured to store and transmit user personal data associated with a user such as, for example, personal calendar data or contact data. For example, user device 48 may store a personal calendar including calendar data associated with a user of ATM 16 and may include one or more interfaces for transmitting the calendar data to multifunctional ATM unit 22 via network 14. As another example, user device 48 may include a contact list with contact information for one or more contacts of the user. User device 48 may also be able to transmit and receive user personal data from one or more other sources including one or more web servers 50.

Web servers 50 may be one or more servers storing user personal data related to web accounts associated with a user of ATM 16. For example, a user of ATM 16 may have one or more web-based personal accounts including, for example, a web-based calendar, contact list, and/or social-media account. These accounts may include user personal data such as personal calendar data for the user, data related to “friends,” “followers,” and/or “followees” of the user as indicated by a link between the user's account and another account including, for example, birthdays, events, activities, and/or preferences associated with friend accounts, or any other suitable information according to particular needs.

In operation, multifunctional ATM unit 22 may be used to determine and communicate one or more recommended actions to a user of ATM 16. A user of ATM 16 may input a user identifier using display 18 or another interface, such as an ATM card reader or keypad, of ATM 16. ATM 16 may be associated with financial institution 12. For example, ATM 16 may be owned and operated by financial institution 12 or may be owned and operated by another entity and may allow for transactions related to accounts serviced by financial institution 12, related to accounts serviced by any other entity, or unrelated to any particular account according to particular needs. ATM 16 may communicate the user identifier associated with the user and a location identifier associated with ATM 16 to multifunctional ATM unit 22 via network 14.

Multifunctional ATM unit 22 may include instructions executed by processor 26 to perform the functions of multifunctional ATM unit 22 as described herein. Multifunctional ATM unit 22 may include rules for determining recommended actions based on information retrieved from ATM 16, user device 48, database 32, and/or one or more web servers 50 and/or any other suitable information for determining a recommended action.

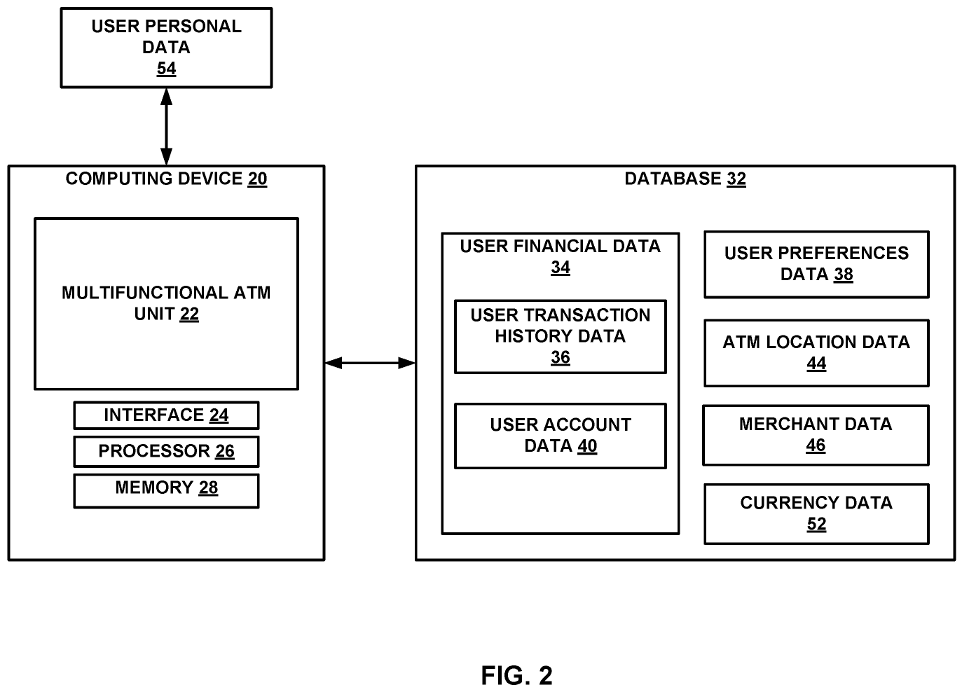

Multifunctional ATM unit 22 may access, via network 14, information in database 32 associated with the user identifier and/or the location identifier, as discussed in further detail with reference to FIG. 2, for use in determining a recommended action for the user of ATM 16. Multifunctional ATM unit 22 may additionally access information from user device 48 and/or one or more web servers 50 via network 14 to determine user personal data associated with the user. For example, multifunctional ATM unit 22 may access information from user device 48 and/or one or more web servers 50 and determine calendar data for the user based on the accessed information. Multifunctional ATM unit 22 may determine, based on the location identifier of ATM 16, data retrieved from database 32, and/or user personal data retrieved from user device 48 and/or one or more web servers 50, a recommended action for the user. Multifunctional ATM unit 22 may send, to ATM 16, information associated with the recommended action to be presented to the user via display 18 of ATM 16. The user may then decide whether to accept or reject the recommended action.

FIG. 2 is a block diagram illustrating computing device 20 for executing multifunctional ATM unit 22, as well as database 32 and user personal data 54, which may be accessed by computer device 22 for determining recommended actions for a user of ATM 16. Computing device 20 may include multifunctional ATM unit 22, described above with reference to FIG. 1, interface 24, processor 26, and memory 28. For example, multifunctional ATM unit 22 may be executable by processor 26 or implemented as one or more hardware units of computing device 20. Multifunctional ATM unit 22 may receive user personal data 54 and/or data from database 32 and processor 26 may determine one or more recommended actions based on the received data.

Interface 24 may be an interface for allowing multifunctional ATM unit 22 to communicate with one or more databases, devices and/or networks via one or more networks, e.g. network 14. Interface 24 may include one or more network interface cards, such as Ethernet cards, and/or any other type of device that can send and receive information. In some examples, multifunctional ATM unit 22 utilizes interface 24 to communicate with ATM 16, database 32, user device 48, and/or one or more web servers 50. Although interface 24 is illustrated as being a single interface, any suitable number of interfaces may be used to perform the described functions according to particular needs.

Processor 26 may be configured to implement functionality and/or process instructions for execution within multifunctional ATM unit 22. Processor 26 may include, for example, microprocessors, digital signal processors (DSPs), application specific integrated circuits (ASICs), field-programmable gate array (FPGAs), and/or equivalent discrete or integrated logic circuitry.

Memory 28 may be configured to store information within computing device 20. Memory 28 may include a computer-readable storage medium or computer-readable storage device. In some examples, memory 28 may include one or more of a short-term memory or a long-term memory. Memory 28 may include, for example, random access memories (RAM), dynamic random access memories (DRAM), static random access memories (SRAM), magnetic hard discs, optical discs, floppy discs, flash memories, or forms of electrically programmable memories (EPROM) or electrically erasable and programmable memories (EEPROM). In some examples, memory 28 may store logic (e.g., multifunctional ATM unit 22) for execution by processor 26. Memory 28 may be used by multifunctional ATM unit 22 to temporarily store information during program execution.

Database 32 may include user financial data 34, user preferences data 38, ATM location data 44, merchant data 46, currency data 52, and/or any other suitable data according to particular needs. User financial data 34 may include financial data associated with one or more user identifiers. For example, for a particular user identifier, user financial data 34 may include user transaction history data 36, user account data 40, and/or any other suitable data associated with the user identifier. In certain examples, user financial data 34 may be based on information generated within financial institution 12.

User transaction history data 36 may include information regarding previous transactions associated with a user identifier, whether performed by a user associated with the user identifier and/or performed for accounts associated with the user associated with the user identifier, whether performed by the user associated with the user identifier or performed by other parties including, for example, a joint owner associated with an account. User transaction history data 36 may include information regarding transactions performed by using ATM 16 or any suitable ATM, whether performed using multifunctional ATM unit 22 or not, by using online banking, by performing the transaction with a teller at a retail location of financial institution 12, or by any other suitable method. User transaction history data 36 may include data regarding withdrawals, deposits, purchases from merchants, currency exchanges, and/or any other suitable transactions according to particular needs. User transaction history data 36 may include transactions not associated with any account of financial institution 12 and/or transactions not associated with an account holder of financial institution 12. For example, user transaction history data 36 may include data regarding an exchange of currency by a user who may or may not be an account holder associated with financial institution 12.

User account data 40 may be data indicating information regarding one or more accounts associated with a user identifier. For example, for a given user identifier, user account data 40 may indicate any number of checking, savings, or other types of accounts associated with the user identifier. User account data 40 may include current account balance data and/or historical account balance data for any number of accounts associated with a user identifier. User account data 40 may be used to create user preferences data 38. For example, multifunctional ATM unit 22 may determine, based on historical account balance data, that a particular account associated with a user identifier typically remains within a particular range and may store information in user preferences data 38 indicating that preferred range. Multifunctional ATM unit 22 may use this preferred range in formulating recommended actions in the future.

User preferences data 38 may include information regarding preferences associated with a user identifier. For example, user preferences data 38 may include, for a user identifier associated with multiple accounts, a preference to route all deposits to a particular account of the multiple accounts. As another example, user preferences data 38 may include a preference to route all deposits over a particular threshold amount to a particular account associated with the user identifier. For example, user preferences data 38 may indicate a preference to route all deposits over $5,000 to a particular savings account of the multiple accounts and to otherwise route smaller deposits to a particular checking account of the multiple accounts. As another example, user preferences data 38 may include a preference to receive all withdrawals over a particular threshold amount in an envelope. For example, ATM 16 may be configured to dispense cash in an envelope and user preferences data 38 may indicate a preference for ATMs to dispense all large withdrawals (withdrawals over a specified threshold) in an envelope. As another example, user preferences data 38 may indicate a preference for certain recommended actions to be presented by multifunctional ATM unit 22 and/or to not be presented by multifunctional ATM unit 22. For example, user preferences data 38 may indicate that recommended actions associated with purchases from merchants should not be presented but that recommended actions regarding routing of deposits should be presented.

User preferences data 38 may be created in any suitable manner including, for example, by input from a user associated with a user identifier that explicitly sets user preferences data 38. For example, a user, when initially opening a new account, when activating an ATM card for use of ATMs, or at any other suitable time, may complete a questionnaire including any number of suitable questions for assessing user preferences data 38. A user may also be able to create or modify user preferences data 38 in any suitable manner such as, for example, during an online banking session, during an ATM session using ATM 16 or any other suitable ATM, by communicating preferences to an associate at a retail location of financial institution 12, by mail to or over the phone with a representative or automated system of financial institution 12, or in any other suitable manner according to particular needs.

User preferences data 38 may, in addition or alternatively, be created by multifunctional ATM unit 22 by identifying patterns in user transaction history data 36 to “learn” the preferences of a user. For example, multifunctional ATM unit 22 may determine that a monthly deposit associated with a user identifier is made in the same or a similar amount each month and that a particular amount and/or proportion is deposited in a particular savings account each month and a particular amount and/or proportion is deposited in a particular checking account each month. Multifunctional ATM unit 22 may, based on this determination, create user preferences data 38 to indicate a preference to perform the monthly deposit in this manner. As an additional example, multifunctional ATM unit 22 may determine, based on user transaction history data 36, a pattern of merchant purchases and may use the pattern information to create user preferences data 38. For example, multifunctional ATM unit 22 may determine a pattern of purchasing from a particular merchant, of purchasing a particular type of item, and/or of purchasing items in a particular price range. Multifunctional ATM unit 22 may use this determination to create user preferences data 38 to use in determining a recommended action in the future.

ATM location data 44 may be information used to determine a location of ATM 16 including, for example, geographic coordinates associated with ATM 16. For example, a location identifier, such as an identification number or other identification information, may be associated with ATM 16 and may be sent by ATM 16 to multifunctional ATM unit 22. Multifunctional ATM unit 22 may access ATM location data 44 to determine geographic coordinates and/or other suitable location information associated with ATM 16 based on the location identifier received from ATM 16.

Merchant data 46 may include data regarding one or more merchants. For example, merchant data 46 may include information regarding a merchant's name and location(s). For example, merchant data 46 may include geographic coordinates associated with a particular merchant or, in the case of a merchant with multiple locations, geographic coordinates for each of the multiple locations of the merchant. Merchant data 46 may also indicate a merchant's type. A merchant type may include, for example, “restaurant,” “electronics,” housewares,” “move theater,” or any other suitable type and may indicate more than one type for a particular merchant. Merchant data 46 may also include a pricing categorization including, for example, classification of “$” to indicate a merchant that offers relatively inexpensive goods, a classification of “$$$$$” to indicate a merchant that offers relatively expensive goods as well as categorizations in between including, for example, a classification of “$$$.” Merchant data 46 may include information regarding the types of transactions offered by multifunctional ATM unit 22 for a given merchant. For example, a given merchant may offer gift cards for purchase using multifunctional ATM unit 22, may offer goods for pickup at a merchant location and for purchase using multifunctional ATM unit 22, may offer goods for home delivery and for purchase using multifunctional ATM unit 22, or may offer any other suitable good, credit, and/or service. A given merchant may offer any suitable combination of transaction types. For example, a single merchant may offer purchase of gift cards through multifunctional ATM unit 22 and may also offer purchase of goods for pickup at a merchant location through multifunctional ATM unit 22.

In some examples, one or more merchant may offer sale of entertainment tickets (e.g., for movie, sports, opera, theater, etc.). In some examples, one or more merchants may allow an option to receive a receipt and/or ticket on the customer's mobile phone or other mobile device and the receipt and/or ticket may include a quick response (“QR”) code that may be scanned from the mobile phone or other mobile device for redemption.

Currency data 52 may be information used to determine one or more currencies associated with a particular location. For example, multifunctional ATM unit 22 may access currency data 52 to determine one or currencies associated with geographic coordinates; a country, a city, or other geographic region; and/or other suitable location information.

User personal data 54 may be data received from user device 48 and/or one or more web servers 50. User personal data 54 may include, for example, calendar data retrieved from a calendar stored on user device 48 or within a web-based calendar service stored within one or more web servers 50. As another example, user personal data 54 may include contact information for contacts of a user of ATM 16 such as information stored in a contact list on user device 48 or in a web-based contact list on one or more web servers 50. As another example, user personal data 54 may be data about events, relationships, user activity, or any other suitable data retrieved from a web-based social-media service on one or more web servers 50.

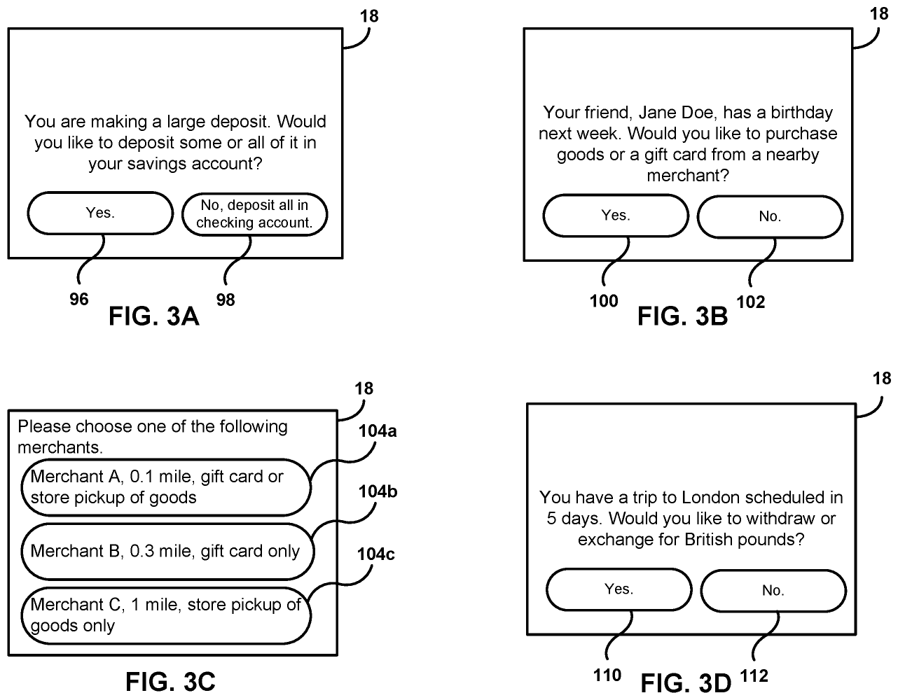

FIGS. 3A-3D illustrate example GUIs presented on display 18 of ATM 16 showing recommended actions that have been determined by multifunctional ATM unit 22 and allowing for user input to accept, reject, or otherwise respond to the recommended action, in accordance with the techniques of this disclosure.

FIG. 3A illustrates an example GUI on display 18 displaying a recommended action to deposit some or all of a large deposit into a savings account, in accordance with the techniques of this disclosure. In this example, a user may indicate a desire to make a deposit. For example, the user may input a user identifier. The user may, for example, input a user identifier by inserting an ATM card with a card number associated with one or more accounts of the user into a card reader on ATM 16 and the card number may be the user identifier. The user identifier may be associated with, for example, a checking account and a savings account. ATM 16 may send the user identifier to multifunctional ATM unit 22 via network 14 and multifunctional ATM unit 22 may receive the user identifier.

Multifunctional ATM unit 22 may determine the checking account and savings account associated with the user identifier based on user financial data 34 retrieved from database 32 via network 14. The default of multifunctional ATM unit 22 may be to route deposits associated with the user identifier into the checking account. However, in the illustrated example, the user may indicate a desire to make a deposit that is over a threshold amount. Based on the desired deposit being over the threshold amount and user financial data 34, multifunctional ATM unit 22 may determine a recommended action of routing some or all of the deposit into a savings account associated with the user identifier. In certain examples, multifunctional ATM unit 22 may determine this recommendation based on user preferences data 38. For example, user preferences data 38 associated with the user identifier may indicate that deposits larger than a threshold amount should be partially or totally deposited in the savings account.

In the illustrated example, the GUI provides accept element 96 to accept the recommended action and reject element 98 to reject the recommended action. Accept element 96 and reject element 98 may be provided as touch-screen elements of the GUI on display 18 such that hovering or pressing a finger or other tool over accept element 96 or reject element 98 may indicate an acceptance or rejection of the recommended action. Alternatively or in addition, the user may be able to indicate an acceptance or rejection of the recommended action using a keypad or other user interface for inputting information.

In the illustrated example, if the user indicates an acceptance of the recommend action, by pressing accept element 96 or in any other suitable manner, multifunctional ATM unit 22 may then facilitate routing of at least a portion of the desired deposit into a savings account associated with the user identifier. For example, multifunctional ATM unit 22 may send information to ATM 16 for displaying options for depositing varying amounts of the deposit into the savings account. If the user indicates a rejection of the recommended action, by pressing reject element 98 or in any other suitable manner, multifunctional ATM unit 22 may then facilitate routing all of the desired deposit into the checking account associated with the user identifier.

FIG. 3B illustrates an example GUI on display 18 displaying a recommended action to purchase goods or a gift card from a nearby merchant based on an upcoming event, in accordance with the techniques of this disclosure. In the illustrated example, the user may input a user identifier, such as a card number associated with one or more accounts of the user, into ATM 16, by, for example, inserting an ATM card into ATM 16. Multifunctional ATM unit 22 may receive the user identifier as well as a location identifier associated with ATM 16 from ATM 16 via network 14. Multifunctional ATM unit 22 may determine, based on the user identifier, user personal data 54 associated with the user identifier. For example, multifunctional ATM unit 22 may determine calendar data associated with the user identifier by accessing calendar data from one or more web servers 50. As another example, multifunctional ATM unit 22 may determine user personal data 54 by retrieving information from a calendar stored in user device 48.

Based on the user personal data 54 from calendar data stored on user device 48 and/or calendar data associated the user identifier within one or more web servers 50, multifunctional ATM unit 22 may determine an upcoming event that may warrant purchase of a gift. For example, in the illustrated example, multifunctional ATM unit 22 may determine an upcoming birthday for a friend associated with the user identifier. For example, user personal data 54 retrieved from a calendar stored on user device 48 and/or from information on one or more web servers 50 may indicate an event, such as a birthday of Jane Doe. In certain examples, the date may indicate another event associated with Jane Doe or another friend or family member of the user, such as a housewarming party, anniversary, or any other suitable event.

Within a social-network service on one or more web servers 50, Jane Doe's profile may show a birthday listed with a particular date and Jane Doe's profile may be in some way connected to a profile associated with the user identifier. For example, a profile associated with the user identifier may be linked with Jane Doe's profile because the two profiles indicate a “friend” and/or “follower” relationship. As another example, the two profiles may be linked as “friend” or “follower” and the two profiles may include frequent interaction. For example, activity of the profile associated with the user identifier may be frequently linked with the activity of Jane Doe's profile such that multifunctional ATM unit 22 may determine, based on the frequent activity between the profiles, that users of the two profiles might be close friends and not merely acquaintances within the social-network service. For example, multifunctional ATM unit 22 may determine that the profiles are frequently tagged in common pictures and/or places, frequently share posts or otherwise communicate, and/or otherwise exhibit interaction that might suitably indicate a closer connection than only a “friend” or “follower” link.

Multifunctional ATM unit 22 may determine that the date of the birthday is close to the date of the current ATM session. For example, multifunctional ATM unit 22 may determine that the date of the birthday is within a week of the date of the ATM session. In certain examples, such as the illustrated example, multifunctional ATM unit 22 may determine that the event date is in the future. In certain examples, multifunctional ATM unit 22 may determine that the event date is the same as the date of the ATM session or that the event is in the recent past.

Multifunctional ATM unit 22 may, based on the location identifier, ATM location data 44, and merchant data 46 stored in database 32, determine that one or more nearby merchants offer purchase of gift cards and/or goods via multifunctional ATM unit 22. For example, multifunctional ATM unit 22 may determine geographic coordinates of ATM 16 based on the location identifier and ATM location data 44. Alternatively or in addition, in certain examples, the location identifier received from ATM 16 may include geographic coordinates associated with ATM 16 such that multifunctional ATM unit 22 need not determine geographic coordinates based on ATM location data 44. Based on the geographic coordinates of ATM 16, multifunctional ATM unit 22 may determine one or more merchants within close proximity to ATM 16 based on merchant data 46. In the illustrated example, multifunctional ATM unit 22 may access merchant data 46 to identify three merchants with at least one location with geographic coordinates within one a mile of the geographic coordinates associated with ATM 16 that offer sale of gift certificates and/or purchase of goods using ATM 16.

In certain examples, additional criteria may be used to determine recommended merchants. For example, user preferences data 38 may indicate a preferred price category for recommended purchases for the user. For example, the user may have previously indicated, by a questionnaire, based on previous merchant purchases, and/or any other suitable method, a preferred price category of “$$” and “$$$” such that recommended merchants may mostly or only include merchants within those price categories. As another example, user preferences data 38 may indicate a preferred merchant type for gifts. For example, user preferences data 38 may indicate that recommended actions to purchase a gift should only include merchants with a type of “restaurant.”

Alternatively or in addition, multifunctional ATM unit 22 may use any other suitable information to identify appropriate merchants for a recommended action. For example, information from one or more web servers 50 may indicate that a potential gift recipient frequents a nearby merchant because the potential gift recipient's social-network account includes one or more “tags” or “check-ins” associated with the merchant and multifunctional ATM unit 22 may use this information to determine a recommended action including a purchase of a gift from the frequented merchant.

In the illustrated example, based on determining an upcoming birthday for Jane Doe and on determining that one or more nearby merchants offer purchase of gift cards and/or goods via ATM 16, multifunctional ATM unit 22 may send information to ATM 16 associated with a recommended action to purchase one or more goods and/or a gift card from a nearby merchant and the information may be displayed on display 18.

In the illustrated example, the GUI provides accept element 100 to accept the recommended action and reject element 102 to reject the recommended action. Accept element 100 and reject element 102 may be provided as touch-screen elements of the GUI on display 18 such that hovering or pressing a finger or other tool over accept element 100 or reject element 102 may indicate an acceptance or rejection of the recommended action. Alternatively or in addition, the user may be able to indicate an acceptance or rejection of the recommended action using a keypad or other user interface for inputting information.

In the illustrated example, if the user indicates a rejection of the recommended action, by pressing reject element 102 or in any other suitable manner, multifunctional ATM unit 22 may receive information from ATM 16 indicating the rejection and may then send information to ATM 16 to change the GUI on display 18 to facilitate performance of other transactions, including deposits or withdrawals, and/or to present additional recommended actions.

In the illustrated example, if the user indicates an acceptance of the recommend action, by pressing accept element 100 or in any other suitable manner, multifunctional ATM unit 22 may, for example, then send information to ATM 16 to change the GUI on display 18 to that of the GUI on display 18 of FIG. 3C to facilitate a purchase from one of the identified merchants.

FIG. 3C illustrates an example GUI on display 18 displaying a list of merchant options, in response to selection of accept element 100 of FIG. 3B, based on the example determinations described with respect to FIG. 3B.

In the illustrated example, the GUI displays merchants in the form of merchant selection elements 104a, 104b, and 104c (collectively “merchant selection elements 104”). Each of merchant selection elements 104 may display information associated with a recommended merchant. For example, merchant selection element 104a may display information about a first merchant, with the name “Merchant A,” located approximately 0.1 mile from ATM 16, and offering gift cards or store pickup of goods for purchase via ATM 16; merchant selection element 104b may display information about a second merchant, with the name “Merchant B,” located approximately 0.3 mile from ATM 16, and offering gift cards for purchase via ATM 16; and merchant selection element 104c may display information about a third merchant, with the name “Merchant C,” located approximately 1 mile from ATM 16, and offering store pickup of goods for purchase via ATM 16.

In certain examples, merchant selection elements 104 may include additional information regarding recommended merchants. For example, one or more of merchant selection elements 104 may indicate a merchant type, a price category, a customer satisfaction rating, and/or any other suitable information that may be useful to the user in selecting one or more merchants from which to make a purchase. In certain examples, one or more merchant selection elements 104 may display information associating the merchant with a potential gift recipient. For example, merchant selection element 104a may indicate frequent “tags” or “check ins” associated with “Merchant A” by a social-media account of Jane Doe within a social-network service on one or more web servers 50 to help the user determine that Jane Doe appears to be a frequent patron of “Merchant A.”

As another example, in certain examples, multifunctional ATM unit 22 may receive a location identifier associated with a potential gift recipient. For example, multifunctional ATM unit 22 may receive location information regarding a potential gift recipient based on information in user device 48, such as a contact list indicating the potential gift recipient's address. As another example, multifunctional ATM unit 22 may receive location information regarding the potential gift recipient based on information in one or more web servers 50. For example, a web-based contact list account associated with the user of ATM 16 may include a contact list that includes an address for the potential gift recipient. As another example, an account associated with the potential gift recipient and somehow linked to the user of ATM 16 on a social-network service on one or more web servers 50 may include location information for the potential gift recipient. For example, the account may indicate a hometown, current town, a home address, and/or a work address and/or may include “check-ins” or other activity that indicates a location for the potential gift recipient. As another example, if the potential gift recipient is a user of ATMs associated with multifunctional ATM unit 22, ATM activity may suggest a location identifier for the potential gift recipient based on frequent use of one or more ATMs in a particular geographic area.

Based on a location identifier of the potential gift recipient, multifunctional ATM unit 22 may identify and recommend merchants in close proximity to the potential gift recipient. In those cases, merchant selection element 104a may indicate a proximity of a location of “Merchant A” to a location associated with the potential gift recipient, as determined based on the location identifier associated with the potential gift recipient or in any other suitable manner according to particular needs.

Merchant selection elements 104 may be provided as touch-screen elements of the GUI on display 18 such that hovering or pressing a finger or other tool over any of merchant selection elements 104 may indicate a selection of a merchant associated with the merchant selection element 104. For example, hovering or pressing a finger or other tool over merchant selection elements 104 may indicate a selection of “Merchant A.” Alternatively or in addition, the user may be able to indicate a selection of a recommended merchant using a keypad or other user interface for inputting information. In the illustrated example, if the user indicates a selection of “Merchant A” by pressing merchant selection element 104a or in any other suitable manner, multifunctional ATM unit 22 may receive information indicating this selection and may send information to ATM 16 to change the GUI of display 18 to facilitate purchase of a gift card or good for store pickup from “Merchant A.” In certain examples, the GUI on display 18 may include an option to navigate “back” to a previous screen, such as that shown in the GUI on display 18 of FIG. 3B, or to cancel a gift purchase and continue with performing other transactions, including deposits or withdrawals or any other suitable transaction, or to end the ATM session.

FIG. 3D illustrates an example GUI on display 18 displaying a recommended action to exchange currency based on an upcoming trip, in accordance with the techniques of this disclosure. As described with reference to FIG. 3B, multifunctional ATM unit 22 may access calendar data from user device 48 or from information in one or more web servers 50, such as calendar data stored by an online service such as, for example, a web-based calendar or social-media account. In the illustrated example, multifunctional ATM unit 22 may determine that the user has an upcoming trip scheduled to a particular destination. For example, in certain examples, multifunctional ATM unit 22 may determine that a scheduled trip is within two weeks of the date of the ATM session.

Based on a location identifier associated with ATM 16, ATM location data 44, and/or currency data 52, multifunctional ATM unit 22 may determine a local currency associated with the location identifier. Multifunctional ATM unit 22 may also, based on the trip destination and currency data 52, determine a local currency associated with the particular destination of the scheduled trip. Multifunctional ATM unit 22 may determine that the local currency associated with the location identifier of ATM 16 is different from the local currency associated with the particular destination of the scheduled trip. Based on determining that the local currency associated with the location identifier of ATM 16 is different than the local currency associated with the particular destination of the scheduled trip and that the trip is scheduled within a particular timeframe, for example, within two weeks, multifunctional ATM unit 22 may determine a recommended action of withdrawing funds in the local currency associated with the trip destination by exchanging funds in the local currency associated with the location identifier of ATM 16 for funds in the local currency associated with the trip destination or withdrawing funds from an account in the local currency associated with the trip destination.

In the illustrated example, multifunctional ATM unit 22 determines that the user has a trip to London scheduled in five days and determines that the local currency associated with the location identifier, for example, U.S. dollars for ATM 16 located in the U.S., is different than the local currency in London and may determine a recommended action to withdraw funds in British pounds by exchanging U.S. dollars or withdrawing funds in British pounds from an account of the user. Multifunctional ATM unit 22 may send information associated with the recommended action to ATM 16 for display on display 18 on ATM 16.

In the illustrated example, the GUI provides accept element 110 to accept the recommended action and reject element 112 to reject the recommended action. Accept element 110 and reject element 112 may be provided as touch-screen elements of the GUI on display 18 such that hovering or pressing a finger or other tool over accept element 110 or reject element 112 may indicate an acceptance or rejection of the recommended action. Alternatively or in addition, the user may be able to indicate an acceptance or rejection of the recommended action using a keypad or other user interface for inputting information.

In the illustrated example, if the user indicates a rejection of the recommended action, by pressing reject element 112 or in any other suitable manner, information indicating the rejection may be sent from ATM 16 to multifunctional ATM unit 22. Multifunctional ATM unit 22 may receive the information and may determine information to be displayed in response to the rejection. Multifunctional ATM unit 22 may send the determined information to ATM 16 for display on display 18 to facilitate performance of other transactions, including deposits or withdrawals, and/or to present additional recommended actions. In the illustrated example, if the user indicates an acceptance of the recommend action, by pressing accept element 110 or in any other suitable manner, multifunctional ATM unit 22 may, for example, then facilitate a withdrawal of British pounds.

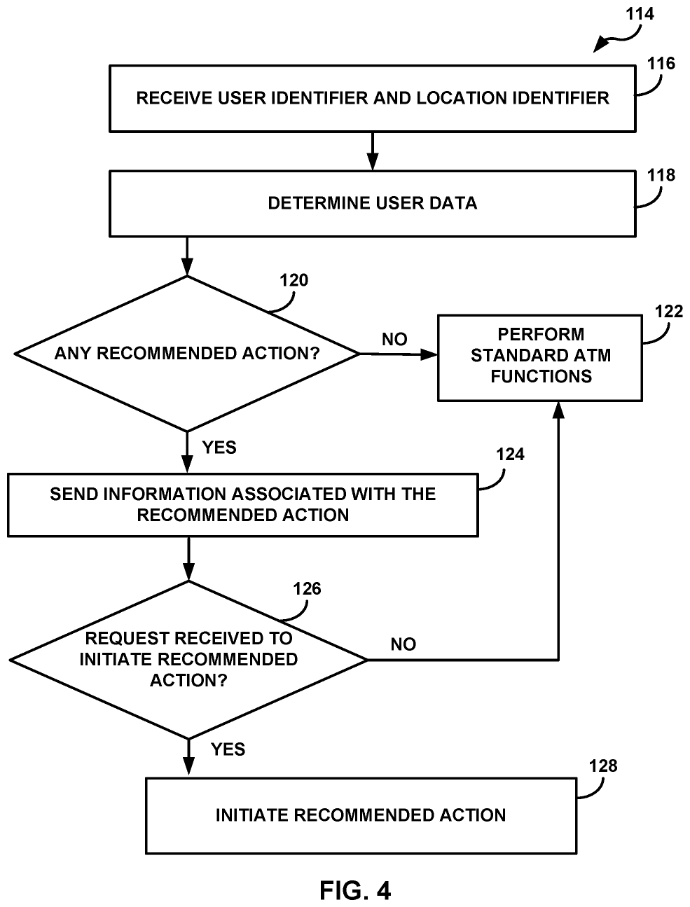

FIG. 4 is a flowchart illustrating an example operation 114 of multifunctional ATM unit 22 of multifunctional ATM system 10, in accordance with the techniques of this disclosure. The example operation 114 is described with respect to multifunctional ATM unit 22 of computing device 20 from FIG. 2.

Multifunctional ATM unit 22 may receive a user identifier and a location identifier from ATM 16 (116). The user identifier may be associated with the user of ATM 16 and the location identifier may be associated with ATM 16. For example, the user may enter an ATM card into ATM 16 which may include a user identifier in the form of an ATM card number and may prompt initiation of an ATM session for the user and communication of the user identifier and location identifier to multifunctional ATM unit 22. In certain examples, the user may input a user identifier by using a keypad or by any other suitable manner. In certain examples, the user may be required to enter a PIN number and/or any other suitable credential to initiate the ATM session and/or prompt the communication of the location identifier and/or user identifier to multifunctional ATM unit 22.

Multifunctional ATM unit 22 may determine user data associated with the user based on the user identifier (118). User data associated with the user identifier may include user financial data 34, user preferences data 38, and/or user personal data 54 associated with the user identifier. For example, multifunctional ATM unit 22 may determine user financial data 34, including user transaction history data 36 and/or user account data 40, stored in database 32 based on the user identifier. As another example, multifunctional ATM unit 22 may determine user preferences data 38 stored in database 32 based on the user identifier. For example, database 32 may associate particular user financial data 34 and user preferences data 38 with the user identifier such that database 32 may be accessed to look up user financial data 34 and user preferences data 38 particular to the user identifier.

Alternatively or in addition, multifunctional ATM unit 22 may use the user identifier to retrieve user personal data 54 from user device 48 and/or one or more web servers 50. For example, multifunctional ATM unit 22 may retrieve user personal data 54, such as calendar data, contacts data, and social-media data from user device 48 or one or more web servers 50, as discussed above with reference to FIG. 3B.

In certain examples, multifunctional ATM unit 22 may access user device 48 and/or one or more web servers 50 to identify a location identifier for one or more contacts associated with the user, as discussed previously with reference to FIGS. 3B-3C. In certain examples, multifunctional ATM unit 22 may determine a location identifier for the user of ATM 16 based on the location identifier of ATM 16 and/or other ATMs used by the user, based on information in database 32, or in any other suitable manner. In certain examples, multifunctional ATM unit 22 may retrieve data from user device 48 and/or one or more web servers 50 during an ATM session of the user and may temporarily store the data in memory 28 for determining a recommended action during that ATM session.

Multifunctional ATM unit 22 may determine whether any recommended actions are appropriate for the user (120). If multifunctional ATM unit 22 does not determine any appropriate recommended actions (NO branch 120), the operation may continue with multifunctional ATM unit 22 performing standard ATM functions, such as withdrawals and/or deposits (122). If multifunctional ATM unit 22 determines an appropriate recommended action (YES branch of 120), the operation may continue with multifunctional ATM unit 22 sending information associated with the recommended action to ATM 16 (124).

In certain examples and as discussed with reference to FIGS. 3B and 3C, determining the recommended action may include determining at least one merchant associated with the location identifier of ATM 16 and determining a recommended transaction with the at least one merchant associated with the location identifier. For example, in certain examples, multifunctional ATM unit 22 may determine one or more merchants within a particular distance of ATM 16 that offer purchases of goods, services, and/or any other suitable offering based on the location identifier, ATM location data 44, and merchant data 46.

For example, multifunctional ATM unit 22 may determine geographic coordinates or other location information based on the location identifier and/or ATM location data 44. Multifunctional ATM unit 22 may determine location information including, for example, geographic coordinates, for merchants based on merchant data 46 in database 32 or in any other suitable manner. Multifunctional ATM unit 22 may compare location information for ATM 16 to location information of merchants in merchant data 46 to identify merchants within a convenient distance from ATM 16. For example, multifunctional ATM unit 22 may identify merchants within one mile of ATM 16.

Multifunctional ATM unit 22 may also determine merchants with offerings suitable for a recommended action. For example, based on data in merchant data 46, multifunctional ATM unit 22 may determine merchants offering purchases of goods for in-store pickup and/or merchants offering purchases of goods or services in the form of gift cards via ATM 16. Based on determining merchants within a desirable distance from ATM 16 and offering purchase of gift cards and/or goods for in-store pickup using ATM 16, multifunctional ATM unit 22 may determine a recommended action of purchasing goods for in-store pickup and/or a gift card from a list of recommended merchants.

In certain examples, the recommended action may include an option to purchase a gift card from a merchant within a convenient distance of ATM 16 and the ATM 16 may be configured to print a gift card associated with the merchant. For example, the user may select an option to purchase a gift card from a list of recommended merchants, may specify the gift card amount, and whether to purchase the gift card with funds from an account associated with the user identifier and/or with cash or another payment type that may be used with ATM 16. In certain examples, the user may additionally select a gift card message, design, and/or any other suitable customizable options for the gift card.

When the user has confirmed all selections for the gift card and supplied a method of payment, ATM 16 may print the gift card. Alternatively, the user may choose to have the gift card mailed to any suitable mailing address, including a mailing address of the user or the gift card recipient or any other suitable mailing address. In certain examples, the user may select to have the gift card sent as an e-mail to the gift recipient's e-mail address or any other suitable e-mail address or delivered in any other suitable manner including, for example, sending as a text message or as an alert on a mobile application. In certain examples, the user may choose to have an e-mail alert sent to the gift recipient that may alert the recipient that the gift card is available for pickup at ATM 16 and/or any other suitable ATM with any suitable location.

In certain examples, multifunctional ATM unit 22 may receive a location identifier associated with a potential gift recipient and may identify recommended merchants based on the location identifier associated with the potential gift recipient instead of or in addition to the location identifier of ATM 16. For example, multifunctional ATM unit 22 may receive a location identifier associated with the potential gift recipient based on receiving data such as an address saved in user device 48 for the potential gift recipient, location data in one or more web servers 50 associated with the potential gift recipient, and/or user financial data 34 which, if the recipient is an account holder or otherwise associated with financial institution 12 and/or a user of multifunctional ATM unit 22, may include location information for the potential gift recipient. A location identifier for a potential gift recipient may also be retrieved from a device associated with the potential gift recipient. For example, a device associated with the potential gift recipient may include GPS data that may be transmitted to one or more web servers 50 and accessed by multifunctional ATM unit 22 via network 14 and used as a location identifier for the potential gift recipient for determining a recommended action.

Multifunctional ATM unit 22 may determine a list of recommended merchants based on the identified location of the potential gift recipient. In certain examples, multifunctional ATM unit 22 may determine a recommended action based on receipt of a location identifier associated with the user of ATM 16. For example, multifunctional ATM unit 22 may receive a location identifier from user device 48, from one or more web servers 50 based on the user's information on one or more social media accounts within one or more web servers 50, and/or in any suitable manner according to particular needs.

In some examples, multifunctional ATM unit 22 is configured to receive, from ATM 16, a request to perform a transaction. The request to perform a transaction may include a transaction amount and determining the recommended action may be based on the transaction amount. For example, as illustrated in FIG. 3A, the recommended action may be to deposit all or a portion of a large deposit in a savings account. Multifunctional ATM unit 22 may determine a recommended action based on the transaction amount for a requested deposit transaction. Determining the recommended action may also be based on any other suitable information including user preferences data 38 in database 32. For example, user preferences data 38 may indicate a preference for depositing at least a portion of deposits over a certain threshold amount into a savings account. As another example, user preferences data 38 may indicate a preference to route all deposits to a savings account when a balance of a checking account is over a particular amount.

As another example, a request to perform a transaction may be a request to withdraw funds and may indicate a withdrawal amount. Based on any suitable information, including information in user preferences data 38 and/or any other suitable information, multifunctional ATM unit 22 may determine a recommendation, based on the withdrawal amount, that at least a portion of the withdrawal be made from a particular account associated with the user identifier.

As another example, multifunctional ATM unit 22 may determine, based on the user account data 40 and user transaction history data 36 of user financial data 34 associated with the user identifier, that it would be best to take only a portion of the withdrawal from a checking account, based on the current balance in the checking account and based on expected withdrawals from the checking account, and to take the remaining balance from a savings account with more funds, smaller expected withdrawals, and/or both. For example, based on user transaction history data 36 and/or scheduled withdrawal events such as a scheduled debit to pay a bill, multifunctional ATM unit 22 may predict an upcoming debit to the account. Based on the predicted debit amount and timeframe, the current account balance, and the requested withdrawal amount, multifunctional ATM unit 22 may determine that the withdrawal might result in insufficient funds for the predicted debit event and may therefore determine a recommended action of withdrawing at least a sufficient portion of the withdrawal amount from another account to avoid having insufficient funds in the account with the expected debit event.

As another example, user preferences data 38 may indicate a preferred account balance range for a particular account such that, if a deposit or withdrawal would result in an account balance above or below that range, multifunctional ATM unit 22 may recommend depositing or withdrawing at least a portion to or from another account in order to keep the account balance within the preferred range. In certain examples, multifunctional ATM unit 22 may determine a recommended action including a recommended deposit and/or withdrawal allocation among numerous accounts. In certain examples, multifunctional ATM unit 22 may generically determine a recommendation to deposit and/or withdraw at least a portion of funds to or from a particular account or group of accounts without determining a recommended allocation.

In certain examples, the recommended action may include purchasing an investment product. For example, multifunctional ATM unit 22 may receive a request to deposit a large amount of funds over a threshold amount. Multifunctional ATM unit 22 may determine that a checking account and savings account associated with the user identifier associated with the request have large current balances over certain threshold amounts and/or over a cumulative threshold amount. Based on these determinations, multifunctional ATM unit 22 may determine a recommendation to purchase an investment product such as a savings bond, CD, or any other suitable product. Any suitable threshold amounts may be stored in user preferences data 38 and used to determine a deposit amount and account balance amounts that might suggest that the user associated with the user identifier might be a good candidate for purchasing an investment product.

In certain examples, the recommended action might include opening a savings account. For example, for a user identifier associated with user account data 40 that identifies a checking account with a balance over a first threshold amount and/or a deposit request over a second threshold amount and does not identify any savings account, multifunctional ATM unit 22 may determine that the user associated with the user identifier might be a good candidate for opening a savings account and may determine a recommended action of opening a savings account.

In certain examples, the recommended action may be a recommendation to withdraw foreign currency. For example, as discussed above with reference to FIG. 3D, the location identifier of ATM 16 may be associated with a domestic currency. Multifunctional ATM unit 22 may be able to determine the associated domestic currency based on ATM location data 44, currency data 52, and/or by any other suitable method. Multifunctional ATM unit 22 may predict based on user personal data that the user will be traveling, within a specified time period, to a travel location not associated with the domestic currency. For example, as discussed above with reference to FIG. 3D, multifunctional ATM unit 22 may determine, based on calendar data from user device 48, one or more web servers 50, and/or any other suitable source, that the user has a trip to London, the travel location, scheduled in less than a week.

Multifunctional ATM unit 22 may determine, based on currency data 52, a currency associated with London, the travel location, and may determine that the currency associated with the location identifier of ATM 16 or the user is different than the currency associated with London. In the illustrated example of FIG. 3D, multifunctional ATM unit 22 may determine that British pounds are the foreign currency associated with the travel location. Multifunctional ATM unit 22 may determine a recommended action including requesting withdrawing the foreign currency. For example, the recommended action may include withdrawing or exchanging for funds in the foreign currency.

In some examples, multifunctional ATM unit 22 may further provide options for withdrawing or otherwise transferring funds to or from personal lines of credit and/or a brokerage account, in addition to options to transfer funds from savings, checking, time deposit or other accounts.

In certain examples, multifunctional ATM unit 22 may determine a recommended action to receive a withdrawal in an envelope. For example, multifunctional ATM unit 22 may determine that a requested withdrawal is a large withdrawal because it is over a particular threshold amount. Based on the requested withdrawal being over the threshold amount, multifunctional ATM unit 22 may determine a recommended action to receive the withdrawal in an envelope.

Multifunctional ATM unit 22 may send information associated with the recommended action to ATM 16 (124). Display 18 of ATM 16 may then display information associated with the recommended action that may allow the user to make a selection regarding the recommended action. For example, display 18 of ATM 16 may display one of the example GUIs illustrated in FIG. 3A, 3B, 3C or 3D.

In certain examples, the information sent by multifunctional ATM unit 22 to ATM 16 for display to the user may include an explanation for the recommendation. For example, in the example described above with reference to step 120 to withdraw at least a portion of a withdrawal from a savings account because withdrawing the entire amount from the checking account is predicted to result in insufficient funds after completion of an expected debit event, such as payment of a bill, the information may include an explanation for the recommendation. For example, the information may include an indication of the expected debit event, the current balance of the checking account, and the recommendation to withdraw at least a portion from another available account to avoid insufficient funds being in the checking account. For example, the information for display on display 18 may include information such as “You have requested a withdrawal of $500 from the account ending in XXXX. The current account balance is $800 and you have a bill payment to XYZ mortgage in the amount of $600 scheduled in two days. Would you like to withdraw at least a portion of the requested $500 from your account ending in YYYY, which currently has a balance of $20,000 and no scheduled debits?”

When multifunctional ATM unit 22 receives a request from ATM 16 to initiate a recommended action (YES branch of 126), multifunctional ATM unit 22 initiates the recommended action (128). For example, in the examples illustrated in FIG. 3A, 3B, or 3D, the user may select accept elements 96, 100, or 110 respectively to initiate the recommended actions of depositing at least a portion of an initiated deposit in a savings account, purchasing a good for store pickup or a gift card from a nearby merchant, or withdrawing British pounds, respectively. If multifunctional ATM unit 22 does not receive a request to initiate the recommended action (NO branch of 126), the operation may continue with multifunctional ATM unit 22 performing standard ATM functions, e.g., withdrawals and/or deposits (122).

At step 128, multifunctional ATM unit 22 may initiate the recommended action. For example, multifunctional ATM unit 22 may communicate information to ATM 16 to be displayed on display 18 to facilitate performance of the recommended action. For example, as illustrated in FIG. 3C, the information to be displayed may include a list of recommended merchants in response to a selection of element 100 to initiate a gift purchase via the GUI on display 18 of FIG. 3B. As other examples corresponding to recommended actions discussed above with reference to step 120, multifunctional ATM unit 22 may initiate performing a recommended deposit and/or withdrawal allocation, purchasing an investment product, opening a savings account, and/or any other suitable recommended action.

As another example, multifunctional ATM unit 22 may initiate a withdrawal of foreign currency and ATM 16 may be configured to dispense the foreign currency. For example, in the example illustrated in FIG. 3D and further described above with reference to step 120, multifunctional ATM unit 22 may facilitate a withdrawal of British pounds by exchange of U.S. dollars for British pounds and/or a withdrawal from an account in British pounds and ATM 16 may be configured to dispense British pounds.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over a computer-readable medium as one or more instructions or code, and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry, as well as any combination of such components. Accordingly, the term “processor,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless communication device or wireless handset, a microprocessor, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Techniques of this disclosure may provide one or more technical advantages. For example, determining recommended actions for a user of an ATM may allow for a more streamlined user experience that may reduce the number of inputs a user must make when using the ATM. The system may allow an ATM to display information likely applicable to the user without necessitating the user to navigate through numerous menu choices that are not likely applicable. By reducing navigation through likely unnecessary and undesired menus, the system may thus reduce the processing and storage resources needed by the system.

The multifunctional ATM system may also provide options in addition to withdrawals and deposits including, for example, opening a savings account, withdrawing foreign currency by exchanging local currency for foreign currency and/or making a withdrawal from an account in foreign currency, purchasing goods or a gift certificate from a nearby merchant or a merchant near a gift recipient, and/or any other suitable action. This may allow for multiple actions to be performed in a single visit to an ATM that might have previously required using a variety of systems including, for example, a live-teller system at a retail banking location, an online banking system accessed by a personal computer, a foreign-exchange office, and/or a merchant's retail sales system at a retail location or a merchant's website. Allowing a user to perform the multiple actions at an ATM allows for a more convenient and efficient user experience. It may also reduce the number of systems used which may thus reduce the processing and storage resources needed by the other systems and/or reduce total processing and storage resources needed for all of the systems combined.

The multifunctional ATM system may additionally be able to provide support for following regulatory guidelines including facilitating the implementation of anti-money laundering (AML) programs and customer identification programs and maintenance of transaction records. The multifunctional ATM system may also facilitate reporting transactions as required by law, including reporting cash transactions exceeding $10,000 as well as transactions that may appear suspicious based, for example, on rules stored in the multifunctional ATM system or stored in a memory otherwise accessed by multifunctional ATM system.

Various examples have been described. These and other examples are within the scope of the following claims.

1. A method comprising:
receiving, by a computing device and from an automated teller machine, a request to perform a deposit of a transaction amount;
receiving, by the computing device, a user identifier associated with a user of the automated teller machine;
determining, by the computing device and based on the user identifier, user data that includes at least user financial data;
determining that the transaction amount is over a threshold amount;
in response to determining that the transaction amount is over the threshold amount, determining, by the computing device and based on the user financial data and the transaction amount, a recommendation for the user of the automated teller machine to open a savings account;
sending, by the computing device and to the automated teller machine, information associated with the recommendation in order to cause the automated teller machine to display a user interface including the recommendation for the user to open the savings account on a display of the automated teller machine, wherein the user interface includes one or more user input elements;
upon receiving data representative of a selection of a first one of the user input elements of the user interface via the display of the automated teller machine that indicates an acceptance of the recommendation, initiating, by the computing device, a process to open the savings account; and
performing the deposit of the transaction amount into the savings account in response to receiving the data representative of the selection of the first one of the user input elements.

2-12. (canceled)

13. A computing device comprising:
an interface configured to:
receive, from an automated teller machine, a request to perform a deposit of a transaction amount; and
receive, from the automated teller machine, a user identifier associated with a user of the automated teller machine; and
one or more processors configured to:
determine, based on the user identifier, user data that includes at least user financial data;
determine that the transaction amount is over a threshold amount; and
in response to determining that the transaction amount is over the threshold amount, determine, based on the user financial data and the transaction amount, a recommendation for the user of the automated teller machine to open a savings account,
wherein the interface is further configured to send, to the automated teller machine, information associated with the recommendation in order to cause the automated teller machine to display a user interface including the recommendation for the user to open the savings account on a display of the automated teller machine, wherein the user interface includes one or more user input elements;
upon receiving data representative of a selection of a first one of the user input elements of the user interface via the display of the automated teller machine that indicates an acceptance of the recommendation, initiate a process to open the savings account; and
perform the deposit of the transaction amount into the savings account in response to receiving the data representative of the selection of the first one of the user input elements.

14-24. (canceled)

25. A non-transitory computer-readable storage medium having stored thereon instructions that, when executed, cause a processor to:
determine, based on a request to an automated teller machine to perform a deposit of a transaction amount, the transaction amount;
determine, based on a user identifier associated with a user of the automated teller machine, user data that includes at least user financial data;
determine that the transaction amount is over a threshold amount;
in response to determining that the transaction amount is over the threshold amount, determine, based on the user financial data and the transaction amount, a recommendation for the user of the automated teller machine to open a savings account;
send, to the automated teller machine, information associated with the recommendation in order to cause the automated teller machine to display a user interface including the recommendation for the user to open the savings account on a display of the automated teller machine, wherein the user interface includes one or more user input elements;
upon receiving data representative of a selection of a first one of the user input elements of the user interface via the display of the automated teller machine that indicates an acceptance of the recommendation, initiate a process to open the savings account; and
perform the deposit of the transaction amount into the savings account in response to receiving the data representative of the selection of the first one of the user input elements.

26. The method of claim 1, further comprising:
upon receiving data representative of a selection of a second one of the user input elements of the user interface via the display of the automated teller machine that indicates a declination of the recommendation, declining, by the computing device, to initiate the process to open the savings account; and
performing the deposit of the transaction amount into an existing account of the user in response to receiving the data representative of the selection of the second one of the user input elements.

27. The computing device of claim 13, wherein interface is further configured to:
upon receiving data representative of a selection of a second one of the user input elements of the user interface via the display of the automated teller machine that indicates a declination of the recommendation, decline to initiate the process to open the savings account; and
perform the deposit of the transaction amount into an existing account of the user in response to receiving the data representative of the selection of the second one of the user input elements.

28. The non-transitory computer-readable storage medium of claim 25, wherein the instructions further cause the processor to:
upon receiving data representative of a selection of a second one of the user input elements of the user interface via the display of the automated teller machine that indicates a declination of the recommendation, decline to initiate the process to open the savings account; and
perform the deposit of the transaction amount into an existing account of the user in response to receiving the data representative of the selection of the second one of the user input elements.
